(19) United States
(12) Patent Application Publication
(10) Pub. No.: US 2010/0237551 A1
(43) Pub. Date: Sep. 23, 2010

(54) CONNECTOR

(76) Inventor: Grant Gordon Howard Swasbrook, Hastings (NZ)

Correspondence Address: ICE MILLER LLP, ONE AMERICAN SQUARE, SUITE 3100, INDIANAPOLIS, IN, 46282-0200, US

(21) Appl. No.: 12/601,557

(22) PCT Filed: May 23, 2008
(86) PCT No.: PCT/NZ2008/000124

§ 371 Date: May 10, 2010

(30) Foreign Application Priority Data
May 24, 2007 (NZ) 555423

(51) Int. Cl. B25B 1/00

(52) U.S. Cl. 269/86; 29/559

(57) ABSTRACT

A connector including a spacing link, and a first engagement member connected directly or indirectly to the spacing link, and a second engagement member mounted on an extension arm characterised in that the extension arm is mounted with respect to the spacing link so that the extension arm can move from one side of the spacing link to another.

### TECHNICAL FIELD

The present invention relates to a connector. In particular it relates to a device for connecting or clamping sheet materials.

### BACKGROUND ART

Angle clamps, such as those generally known as “C” (often also referred to as “G”) and “F” clamps, are well known in the prior art. Such clamps are commonly used to hold work pieces together, for example while forming a join.

These angle clamps derive their names from the similarity of the shape of their body to the letters “C” or “F”. An angle clamp includes a pair of jaws attached to the body, the jaws being spaced apart and oriented to face one another (opposing jaws). For example in a C clamp one jaw is attached in the vicinity of the upper end of the “C” and oriented straight down. A second jaw is attached in the vicinity of the lower end of the “C” and oriented upwards to face the other jaw.

A similar arrangement is used on an F clamp, with the jaws being fixed on the top and centre bars of the “F”, facing towards each other. The centre bar of the F clamp is usually able to slide along the shaft of the body (corresponding to the vertical stroke of the “F”) to enable the separation of the jaws to be adjusted rapidly.

An angle clamp operates by changing the spacing between the opposing jaws. In a C clamp this is usually achieved by mounting the lower jaw on a threaded bolt which is engaged with the body of the clamp through a complementarily threaded aperture at the bottom end of the “C”. Rotation of the bolt moves the lower jaw directly towards or away from the upper jaw. The arrangement of a threaded bolt having a jaw attached at one end may be referred to as a plunger.

In use an object is placed between the jaws of a C clamp. The distance between the jaws is shortened until the jaws are in contact with the object, thus attaching it to the object. Further movement of the jaws applies pressure to the object. The object is released by reversing the procedure.

An F clamp works in essentially the same manner. However the jaws are initially moved relative to each other by sliding the centre bar along the shaft until the jaws are close to the surface of the object to be clamped. Final adjustment and application of pressure is commonly done using a plunger as described above for a C clamp.

Angle clamps generally require access to at least two opposing surfaces (i.e. two substantially parallel planar surfaces) in order to engage the clamp and to apply a compressive force on a work piece between the jaws of the clamp.

A limitation of such clamps is that opposing surfaces are frequently not available. This may arise if the shape of the piece is such that there are no opposing surfaces, or the opposing surfaces are separated by a distance too large for the clamp to span. In other situations access to opposing surfaces may not be possible due to an obstruction.

This may be illustrated by consideration of a common example, such as connecting together two panels at right angles (to form an L or T shaped join for example). A C or F angle clamp may be used to hold the panels together at the join, provided the clamp can span the width of the panel. It will be readily appreciated by those skilled in the art that the width of the panels may frequently be such that it becomes impractical to use a C or F clamp. For one thing the size of the clamp required to span a large panel may make it unwieldy, or require more than one person to operate.

Angle clamps such as described above are limited to use with opposing surfaces because of their inability to grip onto surfaces that are not substantially parallel.

A number of clamps are known in the prior art, in which at least one of the jaws of the clamp may be attached directly to a planar surface, for example by use of adhesive tape or a suction cup. For example U.S. Pat. No. 7,048,207 discloses an angled clamp that can be attached to a surface using stretch releasing adhesive. However use of this device is limited to clamping to external surfaces meeting at right angles, such as for example the outer surfaces of two panels meeting at a corner edge of a box.

GB Patent No. 2359113 discloses another form of clamp in which the surfaces to be clamped may be gripped by two suction cups connected by a beam, the length of which can be adjusted so as to draw the suction cups together (or push them apart). The suction cups are mounted on arms extending from the beam. At least one of the arms may be pivotally mounted on the beam so that one of the suction cups may swing in an arc directly towards or directly away from the other. This enables the clamp to be attachable to surfaces oriented at a variety of angles.

The clamping device of GB 2359113 can be used to connect two internal surfaces, or two external surfaces, of a pair of planar surfaces meeting along an edge. Such an arrangement of planar surfaces may be generally described as a “V” shape in which the V can vary from a straight line (co-planar surfaces) to an “L” shape.

However, it cannot be used to connect an internal surface to an external surface, which may be a disadvantage in some circumstances.

The usefulness of the clamp may also be limited by the amount of force that can be applied by the suction cups, particularly when the surfaces to be clamped are angled with respect to one another.

This limitation arises because any shortening of the beam to pull the suction cups together, as required in order to apply a clamping force, inevitably generates a force tending to release the suction cups from the surfaces to which they are attached. This tendency to release the suction cups increases as the angle between the surfaces to be clamped increases. Thus, for example, when clamping the internal surfaces forming a right angled corner, it may be that one or other (or both) of the suction cups (or adhesive tape if used) become disengaged from a surface before an adequate clamping force can be applied.

Thus while in principle the clamp of GB Patent No. 2359113 may be used in a wide variety of situations, in practice its usefulness may be limited by the amount of force that can be applied.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### DISCLOSURE OF INVENTION

According to one aspect of the present invention there is provided a connector including

a spacing link, and

a first engagement member connected directly or indirectly to the spacing link, and

a second engagement member mounted on an extension arm

characterised in that

the extension arm is mounted with respect to the spacing link so that the extension arm can move from one side of the spacing link to another.

According to another aspect of the present invention there is provided a connector including

a spacing link substantially aligned in a single plane with a first engagement member, and

a second engagement member mounted on an extension arm

characterised in that

the extension arm is mounted with respect to the spacing link so that the second engagement member is moveable out of the plane of the first engagement member and spacing link.

According to another aspect of the present invention there is provided a connector including

a spacing link, and

a first engagement member connected directly or indirectly to the spacing link, and

a second engagement member mounted on an extension arm

characterised in that

the extension arm is mounted with respect to the spacing link so that the extension arm is moveable out of a plane through the first engagement member and the pivot mounting of the extension arm.

A connector throughout this specification should be understood to refer to a device that connects two or more things together. This includes both instances in which the two things are spatially separated from one another and where they are in contact with one another.

In a preferred embodiment the connector is configured as a clamp.

Reference to a clamp throughout this specification should be understood to refer to a device for holding two or more articles together in contact. A clamp typically is used to exert a compressive force between two articles so as to hold them together in contact.

Reference will be made throughout this specification to a connector in the form of a clamp. However it will be appreciated the present invention may apply to other forms of connector, for example connectors between articles not in contact, and that reference to a clamp only throughout the specification should not be seen as limiting.

For ease of reference the articles to be held may be considered to be two planar sheets of material, such as (without limitation) wooden panels or metal sheets. However, it will be appreciated that a clamp may be used to hold non-planar articles together, and that the description herein in terms of planar sheets of material should not be considered limiting in any manner.

A clamp according to the present invention includes at least two engagement members and a spacing link. The engagement members may be attached directly or indirectly to the spacing link to form a clamp, the clamp configured to enable adjustment of the spacing between the engagement members so as to exert a clamping force on an object or objects in contact with them.

An engagement member for a clamp should be understood as a part of the clamp that in use is in contact with a surface of an article to be clamped.

An engagement member may be a single integrally formed item, such as the jaw of a “G” clamp, or it may include a number of connected parts, of which some part, usually an end, is configured to contact a surface of an article to be clamped. A plunger, as commonly found on C and F clamps, is an example of an engagement member having a number of connected parts.

In all cases the part of the engagement member that in use is in contact with the article to be clamped will be referred to as a contact pad.

In a preferred embodiment at least one engagement member is configured to be releasably attachable to a surface of an article such that, in use, it resists lateral movement of the engagement member with respect to the surface.

In a preferred embodiment at least one engagement member includes a contact pad configured to be releasably attachable to a surface of an article to such that, in use, it resists lateral movement of the contact pad with respect to the surface.

Reference to an engagement member or contact pad that resists lateral movement with respect to a surface to which it is attached should be understood to mean that the engagement member or contact pad, when attached to the surface, will not slide over the surface during normal use, for example when used as a clamp.

The advantage of a clamp having a contact pad that can grip a surface without sliding is that it may be used to apply a compressive force between any two surfaces, irrespective of their relative orientation.

In a preferred embodiment the contact pad is a suction cup.

A suction cup properly fitted to a clean, non-porous surface, resists lateral movement of the suction cup with respect to the surface Adaptors may be used to enable a suction cup to be attached to a wide range of surface conditions.

A suction cup may include a release valve to allow air to flow into the suction cup in order to release the cup from attachment to a surface.

The size and configuration of a suction cup may be chosen to provide the required degree of attachment to a surface.

In some instances it may be preferable to use a vacuum pump to increase the vacuum inside the suction cup, thus increasing the force attaching the suction cup to a surface. A vacuum pump may preferably be in the form of a lever activated piston included as part of the housing of the suction cup, or may be a stand alone pump.

In alternate embodiments the contact pad includes releasable adhesive.

A releasable adhesive refers to a material that can adhere to a surface under normal usage, but where the adhesion can be released by some operation, preferably without leaving any residue on or damage to the surface.

Examples of releasable adhesive are the material applied to paper (or other sheet material) to form 3M's Post It™, and stretch releasing adhesive tape, COMMAND.

Double and single sided adhesive tapes are other well known examples of the use of releasable adhesive.

Releasable adhesive, such as adhesive tape, may be used as the surface of a contact pad to attach an engagement member to an article to be clamped. The tape may be double sided, so that one side may be attached to the surface of a contact pad, or it may be bonded onto the surface of the pad, preferably in a manner than enables the tape to be replaced readily.

As with a suction cup, an adhesive tape may be chosen that provides resistance to lateral movement of the contact pad with respect to the surface of an article to be clamped. An advantage of using a suction cup over adhesive tape (or other forms of adhesive coating) is that a suction cup may be reused numerous times whereas tape usually needs to be replaced after each use. Some releasable adhesive surfaces may be used several times, but by their nature their useful lifetime may be limited by degradation of the adhesive surface (eg., by adhesion of dust or other loose material).

A clamp according to the present invention may also be used to clamp to a porous surface by first placing a self adhesive, non-porous pad onto the porous surface to cover the surface where the suction/cap is to be applied. In this manner the suction cap of the clamp can be attached to the self adhesive, non-porous pad and a good suction achieved and maintained during clamping.

In some embodiments a contact pad may include a hook and loop fastener, such as Velcro™. In such embodiments one element of the fastener, for example a looped strip, may be attached to the contact pad. A complementary hooked strip may be attached to the surface to be clamped. A connection which resists lateral movement may be formed by bringing the two strips together

A clamp according to the present invention may be formed by directly or indirectly attaching a first engagement member to a spacing link. A second engagement member is mounted on an extension arm, which in turn is mounted onto the spacing link.

Reference to a spacing link should be understood to refer to a rigid member that spaces apart and connects, at least in part, the engagement members.

In a preferred embodiment the spacing link is a single rigid member.

A single rigid member is to be understood as a body which is sufficiently stiff to resist bending when a force is applied. In the case of a clamp, the rigidity of the spacing link may be such that it will not bend in use when typical clamping forces are applied.

In other embodiments the spacing link may include a number of components. However, in use these are fixed relative to one another to provide a rigid body for the clamp.

In some embodiments the length of the spacing link may be adjustable. For example a spacing link may be formed from two straight interconnected sections configured such that the sections may slide with respect to one other from one locked position to another, thus changing the effective length of the spacing member. An adjustable spacing link may be used to alter the distance between engagement members attached to each end of the spacing link.

In a preferred embodiment the spacing link is a rigid member configured in an “L” shape.

In other preferred embodiments the spacing link may be a straight rigid member

However, in general a spacing link may be any convenient shape or size, so long as it is rigid and can withstand the clamping forces when applied.

In a preferred embodiment the extension arm is mounted with respect to the spacing link so that the extension arm can move around the spacing link.

In a preferred embodiment the extension arm is a single rigid member.

In other embodiments the extension arm may include a number of components. However, in use these are fixed relative to one another to provide a rigid member.

An extension arm may preferably be a straight rigid bar. Generally, however, a clamp may include an extension arm of any convenient shape.

A second engagement member is mounted on the extension arm, typically in the vicinity of an end.

In a preferred embodiment the second engagement member is a suction cup.

In other embodiments the second engagement member may be a plunger, or (without limitation) an engagement member including a releasable adhesive on the surface of the contact pad.

In a preferred embodiment the second engagement member is pivotally mounted to the extension arm.

Preferably a universal joint, as is well known in the art, is used to pivotally mount a suction cup onto an end of an extension arm. A universal joint is commonly configured to allow movement of an attachment (in this instance a suction cup) up and down and from side to side (and any combination thereof) with respect to a longitudinal axis of the universal joint. The degree of movement in each direction may typically be plus or minus 90°.

Preferably the universal joint is attached to an end of the extension arm so that the universal joint is aligned with a longitudinal axis of the extension arm.

A pivotally connected suction cup can be oriented into any position on the surface of an imaginary hemisphere extending from the longitudinal axis of the extension arm and centred on the pivot point of the universal joint. As a result the suction cup may be attached to the surface of any sheet material oriented to coincide with some point on the surface of an imaginary hemisphere.

In other embodiments other means of pivotal mounting, such as a ball joint or hinge, may be used to attach a suction cup to an extension arm.

The mounting of an extension arm with respect to the spacing link according to the present invention is such that it may move from one side of the spacing link to another.

In a preferred embodiment the extension arm is pivotally mounted with respect to the spacing link.

Preferably the pivot mounting to the spacing link is at the end of the extension arm distal to the mounting for the suction cup.

Preferably the pivotal mounting of the extension arm is located in the vicinity of an end of a planar L shaped spacing link.

Preferably the pivot mounting enables the extension arm to move at least partially around the spacing link. Such movement is in contrast to a pivot mounting in which the extension arm moves through an arc directly towards or away from a side of the spacing link.

The advantage of an extension arm that can move at least partially around the spacing link it that such movement, combined with the pivotal movement of the suction cup attached to the end of the extension arm, enables the suction cup to access (and therefore be attached to) surfaces at a wide variety of orientations with respect to a surface in contact with the first engagement member.

In all preferred embodiments the extension arm is pivotally mounted on the spacing link such that it may move completely around the spacing link. An extension arm mounted in this manner enables a pivotally mounted suction cup on the end of the extension arm to be attached to the surface of any sheet material, no matter how it is oriented with respect to the surface in contact with the first engagement member.

In some embodiments an extension arm may not be free to rotate completely around the spacing link, but have a more limited motion which nevertheless allows the extension arm to move from one side of the spacing link to another. It is envisaged that a clamp in which the extension arm movement is limited to less than a full revolution may be used in specialised applications where the additional degree of freedom of movement of the preferred embodiment is not required.

In a preferred embodiment of the clamp the first engagement member is a plunger mounted on the spacing link.

Reference to a plunger should be understood to refer to an engagement member having a contact pad attached to a threaded bolt which is engaged in a complementarily threaded aperture on the clamp. The aperture may be on the spacing link or may be on an attachment to it. The end of the threaded bolt distal to the end attached to the contact pad is attached to a handle. Turning the handle causes the bolt to rotate in the threaded aperture, thus moving the contact pad with respect to the body containing the aperture.

In some embodiments the plunger may be mounted in the vicinity of the end of the planar L shaped spacing link distal to the pivotal mounting of the extension arm, although in other embodiments the location of the plunger may be adjustable, for example by sliding it along the spacing link and locking it in place at the desired position.

The plunger is mounted on the L shaped spacing link such that the contact pad of the plunger faces the second engagement member.

In other embodiments the first engagement member may be a suction cup or (without limitation) an engagement member including a releasable adhesive on the surface of the contact pad.

In a preferred embodiment the first engagement member is mounted on a second extension arm, wherein the second extension arm is mounted with respect to the spacing link so that the second extension arm can move from one side of the spacing link to another.

In such embodiments the clamp includes at least two extension arms each separately mounted with respect to the spacing link so that each extension arm can move independently from one side of the spacing link to another.

In these embodiments a clamp includes (at least) two extension arms, each separately pivotally mounted onto a spacing link so that each extension arm can move around the spacing link. Each extension arm has an engagement member mounted to it.

The use of a second pivotally mounted extension arm may provide additional freedom of movement to the clamp, allowing the engagement members to be aligned as required in difficult situations, such as when attaching the clamp around an obstacle.

In a preferred embodiment the position of the first engagement member with respect to the second engagement arm is adjustable.

In such embodiments the plunger may be mounted onto a mount that is configured to slide in a slot formed along the extension arm. The mount may be further configured to lock in place in a chosen position, thus holding the plunger fixed for the duration of the clamping action.

The ability to move the plunger along the extension arm allows adjustment of the location of the plunger to a position where it is most appropriately aligned with the engagement member/suction cup on the other extension arm to apply a clamping action. This ability may provide a considerable advantage over clamps where the location of the plunger is fixed (with respect to the spacing link/extension arm) where the position of the plunger may not be optimally aligned with the position of an angled suction cup on the other extension arm for all orientations of the suction cup.

A significant advantage of a clamp according to the present invention is that it may be configured to hold together two contacting planar sheets of material, irrespective of their orientation relative to each other.

According to another aspect of the present invention there is provided a method of using a connector including a spacing link, a first engagement member connected directly or indirectly to the spacing link, and a second engagement member mounted on an extension arm wherein the extension arm is mounted with respect to the spacing link so that the extension arm can move from one side of the spacing link to another,

characterised by the steps of:
a) placing the first engagement member in contact with a surface of a first sheet material; and
b) orienting the spacing link; and
c) rotating the extension arm with respect to the spacing link to bring the second engagement member close to a surface of a second sheet material; and
d) orienting the second engagement member with respect to the extension arm to bring the second engagement member into contact with the surface of the second sheet material; and
e) adjusting the first engagement member to apply a clamping force between the first and second engagement members.

In use the contact pad of the plunger is placed in contact with a surface of one sheet material. The clamp is then oriented by moving the spacing link and extension arm (s) so as to bring the suction cup into the vicinity of a surface of the other sheet material. This can be readily achieved due to the pivotal mounting of the extension arm(s) which allow the extension arms to take any position around the spacing link.

The pivotally mounted suction cup is then oriented with respect to the surface (through operation of the universal joint mounting of the suction pad to the extension arm) and attached to it. A clamping force is applied by rotating (screwing) the plunger so as to pull the suction cup (and attached sheet material) towards the plunger.

Preferably the plunger and suction cup are aligned such that a substantially lateral force is applied to the suction cup (with respect to the surface to which it is attached) when the plunger is rotated. This is facilitated by the numerous degrees of freedom provided (in preferred embodiments) by use of:
two extension arms each independently mounted onto the spacing link so that they can swivel about the spacing link; and
a universal joint to connect the suction cup to its extension arm; and
a slidable mount for the plunger so that the position of the plunger can be adjusted along a length of its extension arm.

The ability to clamp together two planar surfaces, irrespective of their relative orientation, is a significant advantage over “C” clamps and similar prior art devices which are limited to clamping together substantially parallel surfaces only.

A clamp according to the present invention may be used in many other situations where conventional clamps cannot be used. For example, the current clamp may be oriented to get around obstructions which may prevent other clamps from operating.

A further advantage is that a single sized clamp may be used in a wide variety of situations, independent of the size of the work piece. All that is required is that the size is adequate to reach from a suitable position on a surface of one sheet to another position on a surface of another sheet in the vicinity of the join between the sheets.

Clearly the size of the components of the present clamp may be varied to meet the requirements of the application without altering the functionality of the clamp.

Another advantage over the clamps of the prior art is that the present clamp may be oriented in use such that the force applied to the suction cup is largely tangential to the surface to which it is attached. Thus there may be little or no tendency for the suction cup to be released, due to it being pulled away from the surface, when the clamp is tightened.

### BRIEF DESCRIPTION OF DRAWINGS

Further aspects of the present invention will become apparent from the following description which is given by way of example only and with reference to the accompanying drawings in which:

FIG. 1 shows a schematic view of a connector according to one embodiment of the present invention; and

FIG. 2 shows a schematic view of another embodiment of the present invention; and

FIG. 3 shows a schematic view of another embodiment of the present invention; and

FIG. 4 shows a schematic view of one embodiment of the present invention in use.

### BEST MODES FOR CARRYING OUT THE INVENTION

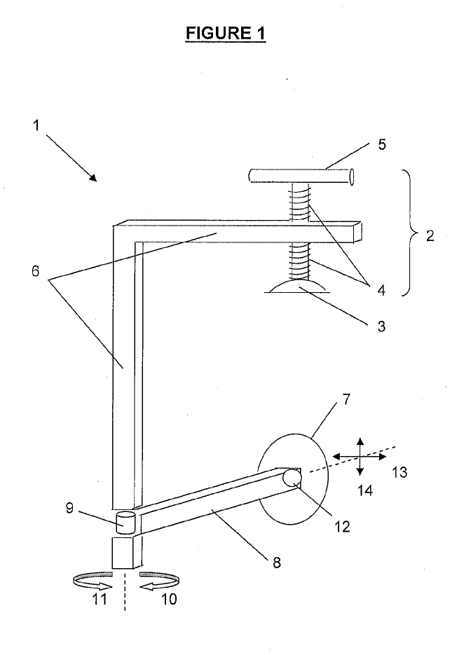

A connector, in the form of a clamp, is generally indicated by arrow 1 in FIG. 1.

A first engagement member, in the form of a plunger is generally indicated by the bracket (2) in FIG. 1.

The plunger includes a contact pad (3) attached to a threaded shaft (4). The connection between the contact pad (3) and the threaded shaft (4) is configured to enable some pivotal orientation of the contact pad (3) with respect to the threaded shaft (4).

The contact pad (3) is in the form of a solid cap having a flat base surface, similar to the contact pads of a conventional G clamp as is well known in the art. In alternative embodiments the contact pad (3) is a suction cup. In yet other embodiments the flat base surface of the contact pad (3) is a releasable adhesive.

The plunger includes a handle (5) attached to the threaded shaft (4) at the end of the shaft distal to the connection to the contact pad (3).

A spacing link (6), in the form of a rigid planar L shaped member, forms a reaction frame for the clamp (1).

The threaded shaft (4) is engaged in a complementarily threaded aperture (not shown) in one arm of the L shaped spacing link (6). With this arrangement rotation of the handle (5) moves the contact pad (3) with respect to the spacing link (6).

A second engagement member, in the form of a suction cup (7) is mounted on an extension arm (8). The extension arm (8) is in the form of a rigid bar.

The extension arm (8) is pivotally mounted on the spacing link (6) at a pivot (9) shown schematically as a cylinder in FIG. 1. The pivot (9) is located on the spacing link (6) in the vicinity of the end of the spacing link (6) distal to the end mounting plunger (2).

The pivotal mounting (9) to the spacing link (6) is such that the extension arm can move in either direction around the spacing link (6), as indicated by the arrows (10) and (11). In this embodiment the extension arm (8) can revolve completely around the spacing link (6).

The suction cup (7) is pivotally mounted onto the extension arm (8) by a universal joint (12) (schematically shown as a circle in FIG. 1). The universal joint (12) allows the suction cup (7) to rotate from side to side and up and down with respect to an axis of the extension arm (8) (shown as a dashed line in FIG. 1) in the directions represented by double headed arrows (13) and (14) respectively. The degree of rotation allowed by the universal joint (12) is typically around plus or minus 90° in each direction (13) and (14).

A clamp (1) in the embodiment shown in FIG. 1 may be used to clamp together any two contacting planar surfaces, irrespective of their orientation with respect to one another.

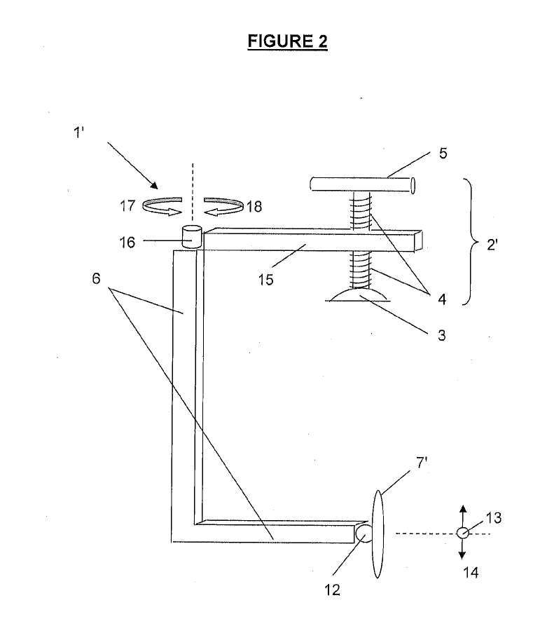

Another embodiment of a connector in the form of a clamp is indicated by arrow (1′) in FIG. 2.

In this embodiment a first engagement member, in the form of a suction cup (7′) is pivotally mounted on a universal joint (12) to an arm of a planar L shaped spacing link (6).

The universal joint (12) is configured to allow the suction cup (7′) to move from side to side and up and down with respect to an axis of the extension arm (8) (as indicated by the dashed line) in the directions indicated by (13) (indicated by the circle as the movement is in and out of the plane of the drawing) and the double headed arrow (14) respectively.

A second engagement member in the form of a plunger (2′) is mounted on an extension arm (15). The mounting of the plunger (2′) on the extension arm (15) is similar to that described above for the previous example.

The extension arm (15) is mounted on the spacing link (6) by a pivot (16), schematically indicated by a cylinder. The pivot (16) is configured to allow the extension arm (15) and attached second engagement member (2′) to move around the spacing link (6) as indicated by the arrows (17) and (18).

The clamp (1′) has the same functionality as the previous embodiment (1). However, in this embodiment the nature of the first and second engagement members has been interchanged.

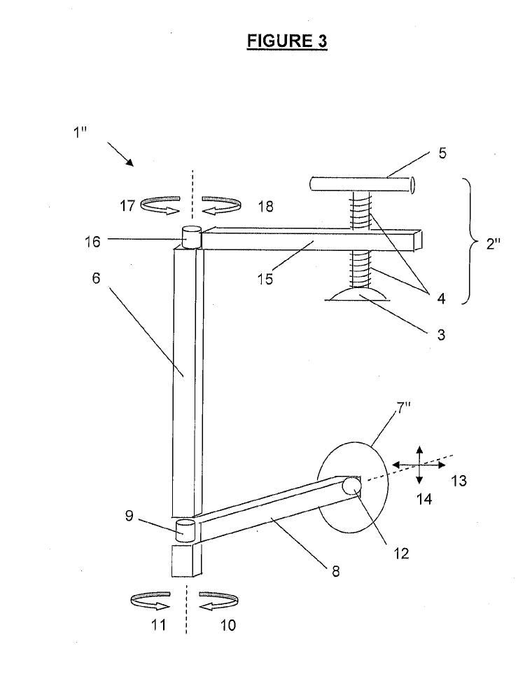

Another embodiment of a connector in the form of a clamp is generally indicated by arrow (1″) in FIG. 3.

In this embodiment the first engagement member, indicated by the bracket (2″) is attached to an extension arm (15). The extension arm (15) is pivotally mounted to the spacing link (6) by the pivot (16), so that the extension arm (15) can rotate in either direction around the spacing link (6) as indicated by arrows (17) and (18).

A second engagement member, in the form of a suction cup (7″) is pivotally attached to a second extension arm (8) by a universal joint (12). The universal joint (12) is configured as previously to allow the suction cup (7″) to move from side to side and up and down with respect to an axis of the extension arm (8) in the directions represented by double headed arrows (13) and (14) respectively.

The extension arm (8) is pivotally mounted to the spacing link (6) by a pivot (9) such that the extension arm (8) can rotate around the spacing link (6) in the directions indicated by the arrows (10) and (11).

The clamp indicated by arrow (1″) in FIG. 3 is a preferred embodiment and clearly incorporates the features of the clamp (1) of FIG. 1 and of clamp (1′) of FIG. 2.

The main advantage of the clamps (1), (1′) and (1″) is that they may be used to clamp together any two contacting planar surfaces, irrespective of their orientation with respect to one another.

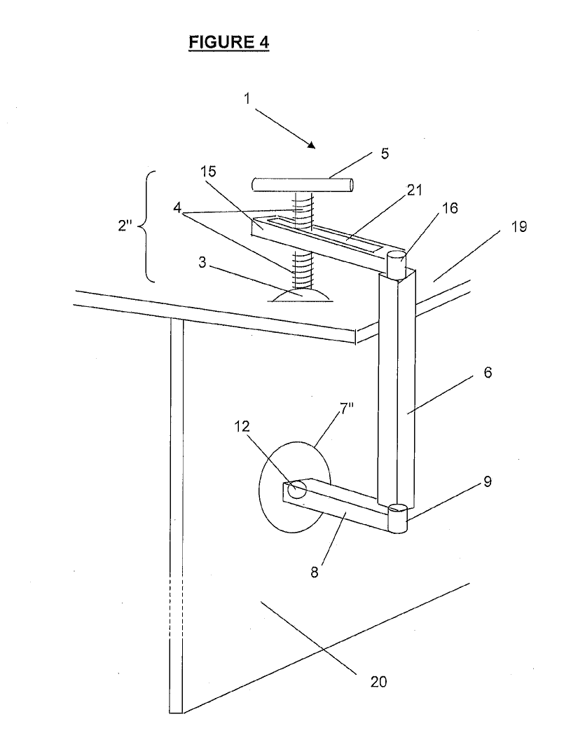

FIG. 4 shows a schematic illustration of how the clamp (1″) may be used to clamp together two planar sheets (19) and (20).

In use the clamp (1″) is arranged so that the contact pad (3) of the plunger (2″) is in contact with the upper surface of the planar sheet (19) in a position approximately above the join running between the planar sheets (19) and (20).

The spacing link (6) is moved into a position such that the suction pad (7) can be attached to a surface of the planar sheet (20) in a position substantially aligned below the position of the contact pad (3).

With the suction cup firmly attached to the surface of the planar sheet (20) the handle (5) of the plunger (2″) is turned so as to draw the suction cup (7) towards the contact pad (3), thus applying a compressive force onto the join between the planar sheets (19) and (20).

The plunger (2″) in this embodiment is mounted with respect to the extension arm (15) such that the position of the plunger (2″) can be adjusted by sliding the mount (not shown) along a slot (21) in the extension arm (15). When in the desired position the mount can be fixed in place, for example by locking the sides of the mount against the sides of the slot (21), or by other means as are well known in the art.

The clamp (1, 1′, 1″) has multiple degrees of freedom arising from the pivots (9) and (16) and the universal joint (12). As a result, the clamp may be oriented to get around obstructions that would prevent the use of other types of clamp, as well as having the ability to manoeuvre into contact with any two contacting planar surfaces. Clearly the size of the various components of the clamps can also be varied to meet the requirements of different applications.

Aspects of the present invention have been described by way of example only and it should be appreciated that modifications and additions may be made thereto without departing from the scope thereof as defined in the appended claims.

What I claim is:

1. A connector comprising:
a spacing link;
a first engagement member connected to the spacing link; and
a second engagement member mounted on an extension arm;
wherein the extension arm is mounted with respect to the spacing link so that the extension arm can move from one side of the spacing link to another.

2. A connector comprising:
a spacing link substantially aligned to a single plane with a first engagement member; and
a second engagement member mounted on an extension arm;
wherein the extension arm is mounted with respect to the spacing link so that the second engagement member is moveable out of the plane of the first engagement member and spacing link.

3. A connector comprising:
a spacing link;
a first engagement member connected to the spacing link; and
a second engagement member mounted on an extension arm;
wherein the extension arm is mounted with respect to the spacing link so that the extension arm is moveable out of a plane through the first engagement member and the mounting of the extension arm.

4. A connector as claimed in claim 1, wherein the extension arm is mounted with respect to the spacing link so that the extension arm can move around the spacing link.

5. A connector as claimed in claim 1, wherein the connector is configured as a clamp.

6. A connector as claimed in claim 1, wherein at least one engagement member is configured to be releasably attachable to a surface of an article such that, in use, it resists lateral movement of the engagement member with respect to the surface.

7. A connector as claimed in claim 6 wherein at least one engagement member includes a contact pad configured to be releasably attachable to a surface of an article such that, in use, it resists lateral movement of the contact pad with respect to the surface.

8. A connector as claimed in claim 7 wherein the contact pad is a suction cup.

9. A connector as claimed in claim 7, wherein the contact pad includes releasable adhesive.

10. A connector as claimed in claim 1, wherein the spacing link is a single rigid member.

11. A connector as claimed in claim 10 wherein the single rigid member is configured in an “L” shape.

12. A connector as claimed in claim 1, wherein the extension arm is a single rigid member.

13. A connector as claimed in claim 1, wherein the second engagement member is pivotally mounted to the extension arm.

14. A connector as claimed in claim 1, wherein the first engagement member is a plunger mounted on the spacing link such that the position of the plunger on the spacing link is adjustable.

15. A connector as claimed in claim 1, wherein the first engagement member is mounted on a second extension arm and the second extension arm is mounted with respect to the spacing link so that the second extension arm can move from one side of the spacing link to another.

16. A connector as claimed in claim 15 wherein the position of the first engagement member with respect to the second engagement arm is adjustable.

17. (canceled)

18. A method of using a connector including a spacing link, a first engagement member connected directly or indirectly to the spacing link, and a second engagement member mounted on an extension arm wherein the extension arm is mounted with respect to the spacing link so that the extension arm can move from one side of the spacing link to another, comprising the steps of:
placing a first engagement member of a connector in contact with a surface of a first sheet material;
orienting a spacing link of the connector;
rotating an extension arm of the connector with respect to the spacing link to bring a second engagement member of the connector close to a surface of a second sheet material;
orienting the second engagement member with respect to the extension arm to bring the second engagement member into contact with the surface of the second sheet material; and
adjusting the first engagement member to apply a clamping force between the first and second engagement members.

19. (canceled)

20. (canceled)

21. A connector as claimed in claim 2, wherein the extension arm is mounted with respect to the spacing link so that the extension arm can move around the spacing link.

22. A connector as claimed in claim 2, wherein the connector is configured as a clamp.

23. A connector as claimed in claim 3, wherein the extension arm is mounted with respect to the spacing link so that the extension arm can move around the spacing link.
